(19) United States
(12) Patent Application Publication
(10) Pub. No.: US 2026/0095825 A1
(43) Pub. Date: Apr. 2, 2026

(54) PRIORITIZATION FOR CELL RESELECTION

(71) Applicant: LG ELECTRONICS INC., Seoul (KR)

(72) Inventor: Sunghoon JUNG, Seoul (KR)

(73) Assignee: LG ELECTRONICS INC., Seoul (KR)

(21) Appl. No.: 19/111,285

(22) PCT Filed: Sep. 27, 2023
(86) PCT No.: PCT/KR2023/015075

§ 371 Date: Mar. 12, 2025

Related U.S. Application Data
(60) Provisional application No. 63/411,179, filed on Sep. 29, 2022.

(51) Int. Cl. H04W 36/00; H04W 24/08; H04W 72/56

(52) U.S. Cl. CPC H04W 36/00835; H04W 24/08; H04W 72/56

(57) ABSTRACT

The present disclosure relates to prioritization for cell reselection in a wireless communication system. According to an embodiment of the present disclosure, a method performed by a user equipment (UE) in a wireless communication system comprises: identifying a cell of which quality is higher than a quality threshold; prioritizing the cell for cell reselection based on i) receiving, from a network, system information informing that the cell is a mobile cell; and ii) a relative mobility state between the UE and the cell; and performing a cell reselection to one of cells including the prioritized cell.

### CROSS-REFERENCE TO RELATED APPLICATION(S)

This application is the National Stage filing under 35 U.S.C. 371 of International Application No. PCT/KR2023/015075, filed on Sep. 27, 2023, which claims the benefit of U.S. Provisional Application No. 63/411,179, filed on Sep. 29, 2022, the contents of which are all incorporated by reference herein in their entirety.

### TECHNICAL FIELD

The present disclosure relates to prioritization for cell reselection in wireless communications.

### BACKGROUND

3rd Generation Partnership Project (3GPP) Long-Term Evolution (LTE) is a technology for enabling high-speed packet communications. Many schemes have been proposed for the LTE objective including those that aim to reduce user and provider costs, improve service quality, and expand and improve coverage and system capacity. The 3GPP LTE requires reduced cost per bit, increased service availability, flexible use of a frequency band, a simple structure, an open interface, and adequate power consumption of a terminal as an upper-level requirement.

Work has started in International Telecommunication Union (ITU) and 3GPP to develop requirements and specifications for New Radio (NR) systems. 3GPP has to identify and develop the technology components needed for successfully standardizing the new RAT timely satisfying both the urgent market needs, and the more long-term requirements set forth by the ITU Radio communication sector (ITU-R) International Mobile Telecommunications (IMT)-2020 process. Further, the NR should be able to use any spectrum band ranging at least up to 100 GHz that may be made available for wireless communications even in a more distant future.

The NR targets a single technical framework addressing all usage scenarios, requirements and deployment scenarios including enhanced Mobile BroadBand (eMBB), massive Machine Type Communications (mMTC), Ultra-Reliable and Low Latency Communications (URLLC), etc. The NR shall be inherently forward compatible.

UE may move while the UE is in connected state or in idle state. In the connected state, the UE may perform a handover to a target cell as the UE moves towards the target cell. In the idle state, the UE may perform a cell reselection as the UE moves. For the cell reselection, the UE may perform prioritization on one or more cells for cell reselection.

### SUMMARY

An aspect of the present disclosure is to provide method and apparatus for prioritization for cell reselection in a wireless communication system.

According to an embodiment of the present disclosure, a method performed by a user equipment (UE) in a wireless communication system comprises: identifying a cell of which quality is higher than a quality threshold; prioritizing the cell for cell reselection based on i) receiving, from a network, system information informing that the cell is a mobile cell; and ii) a relative mobility state between the UE and the cell; and performing a cell reselection to one of cells including the prioritized cell.

According to an embodiment of the present disclosure, a user equipment (UE) configured to operate in a wireless communication system comprises: at least one transceiver; at least one processor; and at least one memory operatively coupled to the at least one processor and storing instructions that, based on being executed by the at least one processor, perform operations comprising: identifying a cell of which quality is higher than a quality threshold; prioritizing the cell for cell reselection based on i) receiving system information informing that the cell is a mobile cell; and ii) a relative mobility state between the UE and the cell; and performing a cell reselection to one of cells including the prioritized cell.

According to an embodiment of the present disclosure, a network node configured to operate in a wireless communication system comprises: at least one transceiver; at least one processor; and at least one memory operatively coupled to the at least one processor and storing instructions that, based on being executed by the at least one processor, perform operations comprising: transmitting, to a user equipment (UE), system information informing that a cell is a mobile cell; and transmitting, to the UE, information for cell reselection parameters, wherein the UE is configured to: identify that a quality of the cell is higher than a quality threshold; prioritize the cell for cell reselection based on i) receiving the system information informing that the cell is the mobile cell, and ii) a relative mobility state between the UE and the cell; and perform a cell reselection to one of cells including the prioritized cell.

According to an embodiment of the present disclosure, a method performed by a network node configured to operate in a wireless communication system comprises: transmitting, to a user equipment (UE), system information informing that a cell is a mobile cell; and transmitting, to the UE, information for cell reselection parameters, wherein the UE is configured to: identify that a quality of the cell is higher than a quality threshold; prioritize the cell for cell reselection based on i) receiving the system information informing that the cell is the mobile cell, and ii) a relative mobility state between the UE and the cell; and perform a cell reselection to one of cells including the prioritized cell.

According to an embodiment of the present disclosure, an apparatus adapted to operate in a wireless communication system comprises: at least processor; and at least one memory operatively coupled to the at least one processor and storing instructions that, based on being executed by the at least one processor, perform operations comprising: identifying a cell of which quality is higher than a quality threshold; prioritizing the cell for cell reselection based on i) receiving system information informing that the cell is a mobile cell; and ii) a relative mobility state between the UE and the cell; and performing a cell reselection to one of cells including the prioritized cell.

According to an embodiment of the present disclosure, a non-transitory computer readable medium (CRM) has stored thereon a program code implementing instructions that, based on being executed by at least one processor, perform operations comprising: identifying a cell of which quality is higher than a quality threshold; prioritizing the cell for cell reselection based on i) receiving system information informing that the cell is a mobile cell; and ii) a relative mobility state between the UE and the cell; and performing a cell reselection to one of cells including the prioritized cell.

The present disclosure may have various advantageous effects.

For example, the UE prioritizes the current serving cell that satisfies the consolidated condition so that the UE can keep camping on the cell.

For example, the UE prioritizes a neighbour cell that satisfies the consolidated condition so that the UE can reselect the cell.

For example, on-board UEs in mobile cell can avoid unnecessary cell reselections, and/or non-onboard UEs can avoid unnecessary reselections.

Advantageous effects which can be obtained through specific embodiments of the present disclosure are not limited to the advantageous effects listed above. For example, there may be a variety of technical effects that a person having ordinary skill in the related art can understand and/or derive from the present disclosure. Accordingly, the specific effects of the present disclosure are not limited to those explicitly described herein, but may include various effects that may be understood or derived from the technical features of the present disclosure.

### BRIEF DESCRIPTION OF THE DRAWINGS

FIG. 1 shows an example of a communication system to which implementations of the present disclosure is applied.

FIG. 2 shows an example of wireless devices to which implementations of the present disclosure is applied.

FIG. 3 shows an example of UE to which implementations of the present disclosure is applied.

FIGS. 4 and 5 show an example of protocol stacks in a 3GPP based wireless communication system to which implementations of the present disclosure is applied.

FIG. 6 shows a frame structure in a 3GPP based wireless communication system to which implementations of the present disclosure is applied.

FIG. 7 shows a data flow example in the 3GPP NR system to which implementations of the present disclosure is applied.

FIGS. 8A to 8E shows examples of Srxlev graphs related to relative mobility state between UE and cell according to an embodiment of the present disclosure.

FIG. 9 shows an example of a method performed by a UE according to an embodiment of the present disclosure.

FIG. 10 shows an example of a signal flow between a network node and a UE according to an embodiment of the present disclosure.

### DETAILED DESCRIPTION

The following techniques, apparatuses, and systems may be applied to a variety of wireless multiple access systems. Examples of the multiple access systems include a Code Division Multiple Access (CDMA) system, a Frequency Division Multiple Access (FDMA) system, a Time Division Multiple Access (TDMA) system, an Orthogonal Frequency Division Multiple Access (OFDMA) system, a Single Carrier Frequency Division Multiple Access (SC-FDMA) system, and a Multi Carrier Frequency Division Multiple Access (MC-FDMA) system. CDMA may be embodied through radio technology such as Universal Terrestrial Radio Access (UTRA) or CDMA2000. TDMA may be embodied through radio technology such as Global System for Mobile communications (GSM), General Packet Radio Service (GPRS), or Enhanced Data rates for GSM Evolution (EDGE). OFDMA may be embodied through radio technology such as Institute of Electrical and Electronics Engineers (IEEE) 802.11 (Wi-Fi), IEEE 802.16 (WiMAX), IEEE 802.20, or Evolved UTRA (E-UTRA). UTRA is a part of a Universal Mobile Telecommunications System (UMTS). 3rd Generation Partnership Project (3GPP) Long-Term Evolution (LTE) is a part of Evolved UMTS (E-UMTS) using E-UTRA. 3GPP LTE employs OFDMA in downlink (DL) and SC-FDMA in uplink (UL). Evolution of 3GPP LTE includes LTE-Advanced (LTE-A), LTE-A Pro, and/or 5G New Radio (NR).

For convenience of description, implementations of the present disclosure are mainly described in regards to a 3GPP based wireless communication system. However, the technical features of the present disclosure are not limited thereto. For example, although the following detailed description is given based on a mobile communication system corresponding to a 3GPP based wireless communication system, aspects of the present disclosure that are not limited to 3GPP based wireless communication system are applicable to other mobile communication systems.

For terms and technologies which are not specifically described among the terms of and technologies employed in the present disclosure, the wireless communication standard documents published before the present disclosure may be referenced.

In the present disclosure, “A or B” may mean “only A”, “only B”, or “both A and B”. In other words, “A or B” in the present disclosure may be interpreted as “A and/or B”. For example, “A, B or C” in the present disclosure may mean “only A”, “only B”, “only C”, or “any combination of A, B and C”.

In the present disclosure, slash (/) or comma (,) may mean “and/or”. For example, “A/B” may mean “A and/or B”. Accordingly, “A/B” may mean “only A”, “only B”, or “both A and B”. For example, “A, B, C” may mean “A, B or C”.

In the present disclosure, “at least one of A and B” may mean “only A”, “only B” or “both A and B”. In addition, the expression “at least one of A or B” or “at least one of A and/or B” in the present disclosure may be interpreted as same as “at least one of A and B”.

In addition, in the present disclosure, “at least one of A, B and C” may mean “only A”, “only B”, “only C”, or “any combination of A, B and C”. In addition, “at least one of A, B or C” or “at least one of A, B and/or C” may mean “at least one of A, B and C”.

Also, parentheses used in the present disclosure may mean “for example”. In detail, when it is shown as “control information (PDCCH)”, “PDCCH” may be proposed as an example of “control information”. In other words, “control information” in the present disclosure is not limited to “PDCCH”, and “PDCCH” may be proposed as an example of “control information”. In addition, even when shown as “control information (i.e., PDCCH)”, “PDCCH” may be proposed as an example of “control information”.

Technical features that are separately described in one drawing in the present disclosure may be implemented separately or simultaneously.

Although not limited thereto, various descriptions, functions, procedures, suggestions, methods and/or operational flowcharts of the present disclosure disclosed herein can be applied to various fields requiring wireless communication and/or connection (e.g., 5G) between devices.

Hereinafter, the present disclosure will be described in more detail with reference to drawings. The same reference numerals in the following drawings and/or descriptions may refer to the same and/or corresponding hardware blocks, software blocks, and/or functional blocks unless otherwise indicated.

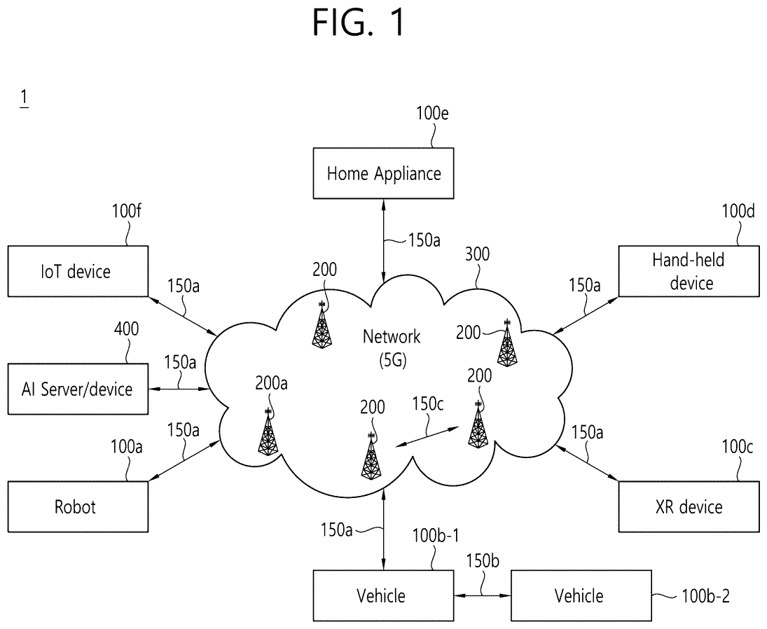

FIG. 1 shows an example of a communication system to which implementations of the present disclosure is applied.

The 5G usage scenarios shown in FIG. 1 are only exemplary, and the technical features of the present disclosure can be applied to other 5G usage scenarios which are not shown in FIG. 1.

Three main requirement categories for 5G include (1) a category of enhanced Mobile BroadBand (eMBB), (2) a category of massive Machine Type Communication (mMTC), and (3) a category of Ultra-Reliable and Low Latency Communications (URLLC).

Referring to FIG. 1, the communication system 1 includes wireless devices 100a to 100f, Base Stations (BSs) 200, and a network 300. Although FIG. 1 illustrates a 5G network as an example of the network of the communication system 1, the implementations of the present disclosure are not limited to the 5G system, and can be applied to the future communication system beyond the 5G system.

The BSs 200 and the network 300 may be implemented as wireless devices and a specific wireless device may operate as a BS/network node with respect to other wireless devices.

The wireless devices 100a to 100f represent devices performing communication using Radio Access Technology (RAT) (e.g., 5G NR or LTE) and may be referred to as communication/radio/5G devices. The wireless devices 100a to 100f may include, without being limited to, a robot 100a, vehicles 100b-1 and 100b-2, an extended Reality (XR) device 100c, a hand-held device 100d, a home appliance 100e, an Internet-of-Things (IOT) device 100f, and an Artificial Intelligence (AI) device/server 400. For example, the vehicles may include a vehicle having a wireless communication function, an autonomous driving vehicle, and a vehicle capable of performing communication between vehicles. The vehicles may include an Unmanned Aerial Vehicle (UAV) (e.g., a drone). The XR device may include an Augmented Reality (AR)/Virtual Reality (VR)/Mixed Reality (MR) device and may be implemented in the form of a Head-Mounted Device (HMD), a Head-Up Display (HUD) mounted in a vehicle, a television, a smartphone, a computer, a wearable device, a home appliance device, a digital signage, a vehicle, a robot, etc. The hand-held device may include a smartphone, a smartpad, a wearable device (e.g., a smartwatch or a smartglasses), and a computer (e.g., a notebook). The home appliance may include a TV, a refrigerator, and a washing machine. The IoT device may include a sensor and a smartmeter.

In the present disclosure, the wireless devices 100a to 100f may be called User Equipments (UEs). A UE may include, for example, a cellular phone, a smartphone, a laptop computer, a digital broadcast terminal, a Personal Digital Assistant (PDA), a Portable Multimedia Player (PMP), a navigation system, a slate Personal Computer (PC), a tablet PC, an ultrabook, a vehicle, a vehicle having an autonomous traveling function, a connected car, an UAV, an AI module, a robot, an AR device, a VR device, an MR device, a hologram device, a public safety device, an MTC device, an IoT device, a medical device, a FinTech device (or a financial device), a security device, a weather/environment device, a device related to a 5G service, or a device related to a fourth industrial revolution field.

The wireless devices 100a to 100f may be connected to the network 300 via the BSs 200. An AI technology may be applied to the wireless devices 100a to 100f and the wireless devices 100a to 100f may be connected to the AI server 400 via the network 300. The network 300 may be configured using a 3G network, a 4G (e.g., LTE) network, a 5G (e.g., NR) network, and a beyond-5G network. Although the wireless devices 100a to 100f may communicate with each other through the BSs 200/network 300, the wireless devices 100a to 100f may perform direct communication (e.g., sidelink communication) with each other without passing through the BSs 200/network 300. For example, the vehicles 100b-1 and 100b-2 may perform direct communication (e.g., Vehicle-to-Vehicle (V2V)/Vehicle-to-everything (V2X) communication). The IoT device (e.g., a sensor) may perform direct communication with other IoT devices (e.g., sensors) or other wireless devices 100a to 100f.

Wireless communication/connections 150a, 150b and 150c may be established between the wireless devices 100a to 100f and/or between wireless device 100a to 100f and BS 200 and/or between BSs 200. Herein, the wireless communication/connections may be established through various RATs (e.g., 5G NR) such as uplink/downlink communication 150a, sidelink communication (or Device-to-Device (D2D) communication) 150b, inter-base station communication 150c (e.g., relay, Integrated Access and Backhaul (IAB)), etc. The wireless devices 100a to 100f and the BSs 200/the wireless devices 100a to 100f may transmit/receive radio signals to/from each other through the wireless communication/connections 150a, 150b and 150c. For example, the wireless communication/connections 150a, 150b and 150c may transmit/receive signals through various physical channels. To this end, at least a part of various configuration information configuring processes, various signal processing processes (e.g., channel encoding/decoding, modulation/demodulation, and resource mapping/de-mapping), and resource allocating processes, for transmitting/receiving radio signals, may be performed based on the various proposals of the present disclosure.

NR supports multiples numerologies (and/or multiple Sub-Carrier Spacings (SCS)) to support various 5G services. For example, if SCS is 15 kHz, wide area can be supported in traditional cellular bands, and if SCS is 30 kHz/60 kHz, dense-urban, lower latency, and wider carrier bandwidth can be supported. If SCS is 60 kHz or higher, bandwidths greater than 24.25 GHz can be supported to overcome phase noise.

The NR frequency band may be defined as two types of frequency range, i.e., Frequency Range 1 (FR1) and Frequency Range 2 (FR2). The numerical value of the frequency range may be changed. For example, the frequency ranges of the two types (FR1 and FR2) may be as shown in Table 1 below. For ease of explanation, in the frequency ranges used in the NR system, FR1 may mean “sub 6 GHz range”, FR2 may mean “above 6 GHz range,” and may be referred to as millimeter Wave (mmW).

TABLE 1

| Frequency Range | Corresponding | Subcarrier |
|---|---|---|
| designation | frequency range | Spacing |
| FR1 | 450 MHz-6000 MHz | 15, 30, 60 kHz |
| FR2 | 24250 MHz-52600 MHz | 60, 120, 240 kHz |

As mentioned above, the numerical value of the frequency range of the NR system may be changed. For example, FR1 may include a frequency band of 410 MHz to 7125 MHz as shown in Table 2 below. That is, FR1 may include a frequency band of 6 GHz (or 5850, 5900, 5925 MHZ, etc.) or more. For example, a frequency band of 6 GHz (or 5850, 5900, 5925 MHz, etc.) or more included in FR1 may include an unlicensed band. Unlicensed bands may be used for a variety of purposes, for example for communication for vehicles (e.g., autonomous driving).

TABLE 2

| Frequency Range | Corresponding | Subcarrier |
|---|---|---|
| designation | frequency range | Spacing |
| FR1 | 410 MHz-7125 MHz | 15, 30, 60 kHz |
| FR2 | 24250 MHz-52600 MHz | 60, 120, 240 kHz |

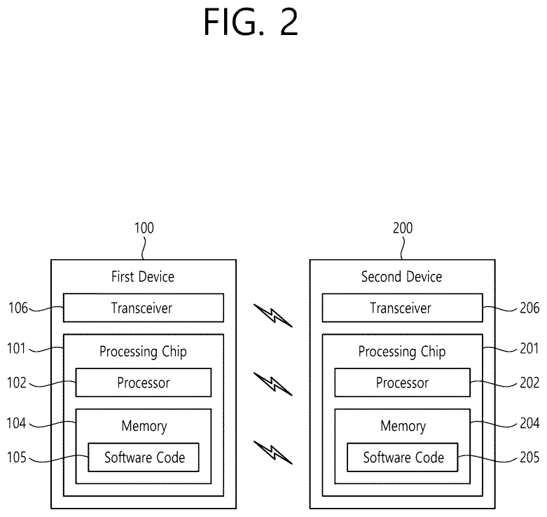

Here, the radio communication technologies implemented in the wireless devices in the present disclosure may include NarrowBand IoT (NB-IOT) technology for low-power communication as well as LTE, NR and 6G. For example, NB-IOT technology may be an example of Low Power Wide Area Network (LPWAN) technology, may be implemented in specifications such as LTE Cat NB1 and/or LTE Cat NB2, and may not be limited to the above-mentioned names. Additionally and/or alternatively, the radio communication technologies implemented in the wireless devices in the present disclosure may communicate based on LTE-M technology. For example, LTE-M technology may be an example of LPWAN technology and be called by various names such as enhanced MTC (eMTC). For example, LTE-M technology may be implemented in at least one of the various specifications, such as 1) LTE Cat 0, 2) LTE Cat M1, 3) LTE Cat M2, 4) LTE non-bandwidth limited (non-BL), 5) LTE-MTC, 6) LTE Machine Type Communication, and/or 7) LTE M, and may not be limited to the above-mentioned names. Additionally and/or alternatively, the radio communication technologies implemented in the wireless devices in the present disclosure may include at least one of ZigBee, Bluetooth, and/or LPWAN which take into account low-power communication, and may not be limited to the above-mentioned names. For example, ZigBee technology may generate Personal Area Networks (PANs) associated with small/low-power digital communication based on various specifications such as IEEE 802.15.4 and may be called various names. FIG. 2 shows an example of wireless devices to which implementations of the present disclosure is applied.

In FIG. 2, The first wireless device 100 and/or the second wireless device 200 may be implemented in various forms according to use cases/services. For example, {the first wireless device 100 and the second wireless device 200} may correspond to at least one of {the wireless device 100a to 100f and the BS 200}, {the wireless device 100a to 100f and the wireless device 100a to 100f} and/or {the BS 200 and the BS 200} of FIG. 1. The first wireless device 100 and/or the second wireless device 200 may be configured by various elements, devices/parts, and/or modules.

The first wireless device 100 may include at least one transceiver, such as a transceiver 106, at least one processing chip, such as a processing chip 101, and/or one or more antennas 108.

The processing chip 101 may include at least one processor, such a processor 102, and at least one memory, such as a memory 104. Additional and/or alternatively, the memory 104 may be placed outside of the processing chip 101.

The processor 102 may control the memory 104 and/or the transceiver 106 and may be adapted to implement the descriptions, functions, procedures, suggestions, methods and/or operational flowcharts described in the present disclosure. For example, the processor 102 may process information within the memory 104 to generate first information/signals and then transmit radio signals including the first information/signals through the transceiver 106. The processor 102 may receive radio signals including second information/signals through the transceiver 106 and then store information obtained by processing the second information/signals in the memory 104.

The memory 104 may be operably connectable to the processor 102. The memory 104 may store various types of information and/or instructions. The memory 104 may store a firmware and/or a software code 105 which implements codes, commands, and/or a set of commands that, when executed by the processor 102, perform the descriptions, functions, procedures, suggestions, methods and/or operational flowcharts disclosed in the present disclosure. For example, the firmware and/or the software code 105 may implement instructions that, when executed by the processor 102, perform the descriptions, functions, procedures, suggestions, methods and/or operational flowcharts disclosed in the present disclosure. For example, the firmware and/or the software code 105 may control the processor 102 to perform one or more protocols. For example, the firmware and/or the software code 105 may control the processor 102 to perform one or more layers of the radio interface protocol.

Herein, the processor 102 and the memory 104 may be a part of a communication modem/circuit/chip designed to implement RAT (e.g., LTE or NR). The transceiver 106 may be connected to the processor 102 and transmit and/or receive radio signals through one or more antennas 108. Each of the transceiver 106 may include a transmitter and/or a receiver. The transceiver 106 may be interchangeably used with Radio Frequency (RF) unit(s). In the present disclosure, the first wireless device 100 may represent a communication modem/circuit/chip.

The second wireless device 200 may include at least one transceiver, such as a transceiver 206, at least one processing chip, such as a processing chip 201, and/or one or more antennas 208.

The processing chip 201 may include at least one processor, such a processor 202, and at least one memory, such as a memory 204. Additional and/or alternatively, the memory 204 may be placed outside of the processing chip 201.

The processor 202 may control the memory 204 and/or the transceiver 206 and may be adapted to implement the descriptions, functions, procedures, suggestions, methods and/or operational flowcharts described in the present disclosure. For example, the processor 202 may process information within the memory 204 to generate third information/signals and then transmit radio signals including the third information/signals through the transceiver 206. The processor 202 may receive radio signals including fourth information/signals through the transceiver 106 and then store information obtained by processing the fourth information/signals in the memory 204.

The memory 204 may be operably connectable to the processor 202. The memory 204 may store various types of information and/or instructions. The memory 204 may store a firmware and/or a software code 205 which implements codes, commands, and/or a set of commands that, when executed by the processor 202, perform the descriptions, functions, procedures, suggestions, methods and/or operational flowcharts disclosed in the present disclosure. For example, the firmware and/or the software code 205 may implement instructions that, when executed by the processor 202, perform the descriptions, functions, procedures, suggestions, methods and/or operational flowcharts disclosed in the present disclosure. For example, the firmware and/or the software code 205 may control the processor 202 to perform one or more protocols. For example, the firmware and/or the software code 205 may control the processor 202 to perform one or more layers of the radio interface protocol.

Herein, the processor 202 and the memory 204 may be a part of a communication modem/circuit/chip designed to implement RAT (e.g., LTE or NR). The transceiver 206 may be connected to the processor 202 and transmit and/or receive radio signals through one or more antennas 208. Each of the transceiver 206 may include a transmitter and/or a receiver. The transceiver 206 may be interchangeably used with RF unit. In the present disclosure, the second wireless device 200 may represent a communication modem/circuit/chip.

Hereinafter, hardware elements of the wireless devices 100 and 200 will be described more specifically. One or more protocol layers may be implemented by, without being limited to, one or more processors 102 and 202. For example, the one or more processors 102 and 202 may implement one or more layers (e.g., functional layers such as Physical (PHY) layer, Media Access Control (MAC) layer, Radio Link Control (RLC) layer, Packet Data Convergence Protocol (PDCP) layer, Radio Resource Control (RRC) layer, and Service Data Adaptation Protocol (SDAP) layer). The one or more processors 102 and 202 may generate one or more Protocol Data Units (PDUs), one or more Service Data Unit (SDUs), messages, control information, data, or information according to the descriptions, functions, procedures, suggestions, methods and/or operational flowcharts disclosed in the present disclosure. The one or more processors 102 and 202 may generate signals (e.g., baseband signals) including PDUs, SDUs, messages, control information, data, or information according to the descriptions, functions, procedures, suggestions, methods and/or operational flowcharts disclosed in the present disclosure and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the descriptions, functions, procedures, suggestions, methods and/or operational flowcharts disclosed in the present disclosure.

The one or more processors 102 and 202 may be referred to as controllers, microcontrollers, microprocessors, or microcomputers. The one or more processors 102 and 202 may be implemented by hardware, firmware, software, or a combination thereof. As an example, one or more Application Specific Integrated Circuits (ASICs), one or more Digital Signal Processors (DSPs), one or more Digital Signal Processing Devices (DSPDs), one or more Programmable Logic Devices (PLDs), or one or more Field Programmable Gate Arrays (FPGAs) may be included in the one or more processors 102 and 202. For example, the one or more processors 102 and 202 may be configured by a set of a communication control processor, an Application Processor (AP), an Electronic Control Unit (ECU), a Central Processing Unit (CPU), a Graphic Processing Unit (GPU), and a memory control processor.

The one or more memories 104 and 204 may be connected to the one or more processors 102 and 202 and store various types of data, signals, messages, information, programs, code, instructions, and/or commands. The one or more memories 104 and 204 may be configured by Random Access Memory (RAM), Dynamic RAM (DRAM), Read-Only Memory (ROM), electrically Erasable Programmable Read-Only Memory (EPROM), flash memory, volatile memory, non-volatile memory, hard drive, register, cash memory, computer-readable storage medium, and/or combinations thereof. The one or more memories 104 and 204 may be located at the interior and/or exterior of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or radio signals/channels, mentioned in the descriptions, functions, procedures, suggestions, methods and/or operational flowcharts disclosed in the present disclosure, to one or more other devices. The one or more transceivers 106 and 206 may receive user data, control information, and/or radio signals/channels, mentioned in the descriptions, functions, procedures, suggestions, methods and/or operational flowcharts disclosed in the present disclosure, from one or more other devices. For example, the one or more transceivers 106 and 206 may be connected to the one or more processors 102 and 202 and transmit and receive radio signals. For example, the one or more processors 102 and 202 may perform control so that the one or more transceivers 106 and 206 may transmit user data, control information, or radio signals to one or more other devices. The one or more processors 102 and 202 may perform control so that the one or more transceivers 106 and 206 may receive user data, control information, or radio signals from one or more other devices.

The one or more transceivers 106 and 206 may be connected to the one or more antennas 108 and 208. Additionally and/or alternatively, the one or more transceivers 106 and 206 may include one or more antennas 108 and 208. The one or more transceivers 106 and 206 may be adapted to transmit and receive user data, control information, and/or radio signals/channels, mentioned in the descriptions, functions, procedures, suggestions, methods and/or operational flowcharts disclosed in the present disclosure, through the one or more antennas 108 and 208. In the present disclosure, the one or more antennas 108 and 208 may be a plurality of physical antennas or a plurality of logical antennas (e.g., antenna ports).

The one or more transceivers 106 and 206 may convert received user data, control information, radio signals/channels, etc., from RF band signals into baseband signals in order to process received user data, control information, radio signals/channels, etc., using the one or more processors 102 and 202. The one or more transceivers 106 and 206 may convert the user data, control information, radio signals/channels, etc., processed using the one or more processors 102 and 202 from the base band signals into the RF band signals. To this end, the one or more transceivers 106 and 206 may include (analog) oscillators and/or filters. For example, the one or more transceivers 106 and 206 can up-convert OFDM baseband signals to OFDM signals by their (analog) oscillators and/or filters under the control of the one or more processors 102 and 202 and transmit the up-converted OFDM signals at the carrier frequency. The one or more transceivers 106 and 206 may receive OFDM signals at a carrier frequency and down-convert the OFDM signals into OFDM baseband signals by their (analog) oscillators and/or filters under the control of the one or more processors 102 and 202.

Although not shown in FIG. 2, the wireless devices 100 and 200 may further include additional components. The additional components 140 may be variously configured according to types of the wireless devices 100 and 200. For example, the additional components 140 may include at least one of a power unit/battery, an Input/Output (I/O) device (e.g., audio I/O port, video I/O port), a driving device, and a computing device. The additional components 140 may be coupled to the one or more processors 102 and 202 via various technologies, such as a wired or wireless connection.

In the implementations of the present disclosure, a UE may operate as a transmitting device in Uplink (UL) and as a receiving device in Downlink (DL). In the implementations of the present disclosure, a BS may operate as a receiving device in UL and as a transmitting device in DL. Hereinafter, for convenience of description, it is mainly assumed that the first wireless device 100 acts as the UE, and the second wireless device 200 acts as the BS. For example, the processor(s) 102 connected to, mounted on or launched in the first wireless device 100 may be adapted to perform the UE behavior according to an implementation of the present disclosure or control the transceiver(s) 106 to perform the UE behavior according to an implementation of the present disclosure. The processor(s) 202 connected to, mounted on or launched in the second wireless device 200 may be adapted to perform the BS behavior according to an implementation of the present disclosure or control the transceiver(s) 206 to perform the BS behavior according to an implementation of the present disclosure.

In the present disclosure, a BS is also referred to as a node B (NB), an eNode B (eNB), or a gNB.

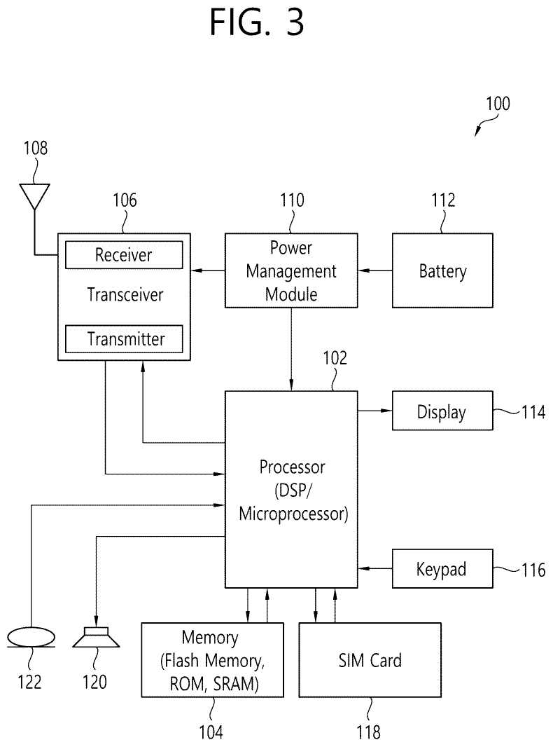

FIG. 3 shows an example of UE to which implementations of the present disclosure is applied.

Referring to FIG. 3, a UE 100 may correspond to the first wireless device 100 of FIG. 2.

A UE 100 includes a processor 102, a memory 104, a transceiver 106, one or more antennas 108, a power management module 141, a battery 142, a display 143, a keypad 144, a Subscriber Identification Module (SIM) card 145, a speaker 146, and a microphone 147.

The processor 102 may be adapted to implement the descriptions, functions, procedures, suggestions, methods and/or operational flowcharts disclosed in the present disclosure. The processor 102 may be adapted to control one or more other components of the UE 100 to implement the descriptions, functions, procedures, suggestions, methods and/or operational flowcharts disclosed in the present disclosure. Layers of the radio interface protocol may be implemented in the processor 102. The processor 102 may include ASIC, other chipset, logic circuit and/or data processing device. The processor 102 may be an application processor. The processor 102 may include at least one of DSP, CPU, GPU, a modem (modulator and demodulator). An example of the processor 102 may be found in SNAPDRAGON™ series of processors made by Qualcomm®, EXYNOS™ series of processors made by Samsung®, A series of processors made by Apple®, HELIO™ series of processors made by MediaTek®, ATOM™ series of processors made by Intel® or a corresponding next generation processor.

The memory 104 is operatively coupled with the processor 102 and stores a variety of information to operate the processor 102. The memory 104 may include ROM, RAM, flash memory, memory card, storage medium and/or other storage device. When the embodiments are implemented in software, the techniques described herein can be implemented with modules (e.g., procedures, functions, etc.) that perform the descriptions, functions, procedures, suggestions, methods and/or operational flowcharts disclosed in the present disclosure. The modules can be stored in the memory 104 and executed by the processor 102. The memory 104 can be implemented within the processor 102 or external to the processor 102 in which case those can be communicatively coupled to the processor 102 via various means as is known in the art.

The transceiver 106 is operatively coupled with the processor 102, and transmits and/or receives a radio signal. The transceiver 106 includes a transmitter and a receiver. The transceiver 106 may include baseband circuitry to process radio frequency signals. The transceiver 106 controls the one or more antennas 108 to transmit and/or receive a radio signal.

The power management module 141 manages power for the processor 102 and/or the transceiver 106. The battery 142 supplies power to the power management module 141.

The display 143 outputs results processed by the processor 102. The keypad 144 receives inputs to be used by the processor 102. The keypad 144 may be shown on the display 143.

The SIM card 145 is an integrated circuit that is intended to securely store the International Mobile Subscriber Identity (IMSI) number and its related key, which are used to identify and authenticate subscribers on mobile telephony devices (such as mobile phones and computers). It is also possible to store contact information on many SIM cards.

The speaker 146 outputs sound-related results processed by the processor 102. The microphone 147 receives sound-related inputs to be used by the processor 102.

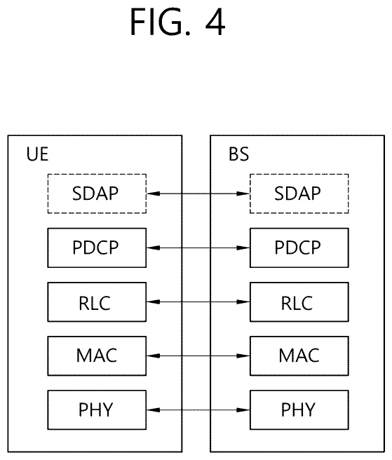

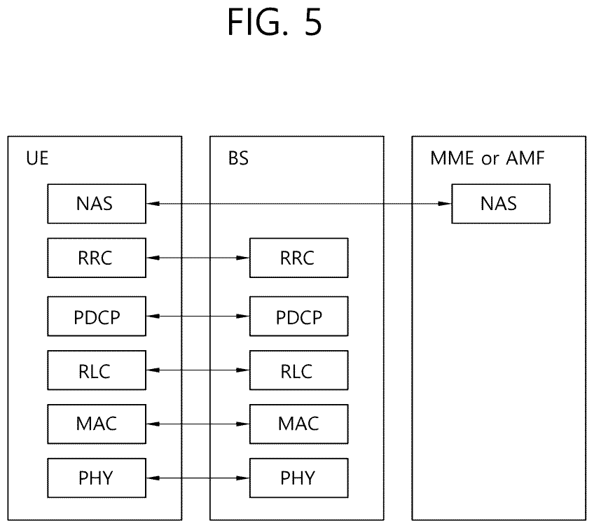

FIGS. 4 and 5 show an example of protocol stacks in a 3GPP based wireless communication system to which implementations of the present disclosure is applied.

In particular, FIG. 4 illustrates an example of a radio interface user plane protocol stack between a UE and a BS and FIG. 5 illustrates an example of a radio interface control plane protocol stack between a UE and a BS. The control plane refers to a path through which control messages used to manage call by a UE and a network are transported. The user plane refers to a path through which data generated in an application layer, for example, voice data or Internet packet data are transported. Referring to FIG. 4, the user plane protocol stack may be divided into Layer 1 (i.e., a PHY layer) and Layer 2. Referring to FIG. 5, the control plane protocol stack may be divided into Layer 1 (i.e., a PHY layer), Layer 2, Layer 3 (e.g., an RRC layer), and a non-access stratum (NAS) layer. Layer 1, Layer 2 and Layer 3 are referred to as an access stratum (AS).

In the 3GPP LTE system, the Layer 2 is split into the following sublayers: MAC, RLC, and PDCP. In the 3GPP NR system, the Layer 2 is split into the following sublayers: MAC, RLC, PDCP and SDAP. The PHY layer offers to the MAC sublayer transport channels, the MAC sublayer offers to the RLC sublayer logical channels, the RLC sublayer offers to the PDCP sublayer RLC channels, the PDCP sublayer offers to the SDAP sublayer radio bearers. The SDAP sublayer offers to 5G core network quality of service (QoS) flows.

In the 3GPP NR system, the main services and functions of the MAC sublayer include: mapping between logical channels and transport channels; multiplexing/de-multiplexing of MAC SDUs belonging to one or different logical channels into/from transport blocks (TB) delivered to/from the physical layer on transport channels; scheduling information reporting; error correction through hybrid automatic repeat request (HARQ) (one HARQ entity per cell in case of carrier aggregation (CA)); priority handling between UEs by means of dynamic scheduling; priority handling between logical channels of one UE by means of logical channel prioritization; padding. A single MAC entity may support multiple numerologies, transmission timings and cells. Mapping restrictions in logical channel prioritization control which numerology(ies), cell(s), and transmission timing(s) a logical channel can use.

Different kinds of data transfer services are offered by MAC. To accommodate different kinds of data transfer services, multiple types of logical channels are defined, i.e., each supporting transfer of a particular type of information. Each logical channel type is defined by what type of information is transferred. Logical channels are classified into two groups: control channels and traffic channels. Control channels are used for the transfer of control plane information only, and traffic channels are used for the transfer of user plane information only. Broadcast control channel (BCCH) is a downlink logical channel for broadcasting system control information, paging control channel (PCCH) is a downlink logical channel that transfers paging information, system information change notifications and indications of ongoing public warning service (PWS) broadcasts, common control channel (CCCH) is a logical channel for transmitting control information between UEs and network and used for UEs having no RRC connection with the network, and dedicated control channel (DCCH) is a point-to-point bi-directional logical channel that transmits dedicated control information between a UE and the network and used by UEs having an RRC connection. Dedicated traffic channel (DTCH) is a point-to-point logical channel, dedicated to one UE, for the transfer of user information. A DTCH can exist in both uplink and downlink. In downlink, the following connections between logical channels and transport channels exist: BCCH can be mapped to broadcast channel (BCH); BCCH can be mapped to downlink shared channel (DL-SCH); PCCH can be mapped to paging channel (PCH); CCCH can be mapped to DL-SCH; DCCH can be mapped to DL-SCH; and DTCH can be mapped to DL-SCH. In uplink, the following connections between logical channels and transport channels exist: CCCH can be mapped to uplink shared channel (UL-SCH); DCCH can be mapped to UL-SCH; and DTCH can be mapped to UL-SCH.

The RLC sublayer supports three transmission modes: transparent mode (TM), unacknowledged mode (UM), and acknowledged node (AM). The RLC configuration is per logical channel with no dependency on numerologies and/or transmission durations. In the 3GPP NR system, the main services and functions of the RLC sublayer depend on the transmission mode and include: transfer of upper layer PDUs; sequence numbering independent of the one in PDCP (UM and AM); error correction through ARQ (AM only); segmentation (AM and UM) and re-segmentation (AM only) of RLC SDUs; reassembly of SDU (AM and UM); duplicate detection (AM only); RLC SDU discard (AM and UM); RLC re-establishment; protocol error detection (AM only).

In the 3GPP NR system, the main services and functions of the PDCP sublayer for the user plane include: sequence numbering; header compression and decompression using robust header compression (ROHC); transfer of user data; reordering and duplicate detection; in-order delivery; PDCP PDU routing (in case of split bearers); retransmission of PDCP SDUs; ciphering, deciphering and integrity protection; PDCP SDU discard; PDCP re-establishment and data recovery for RLC AM; PDCP status reporting for RLC AM; duplication of PDCP PDUs and duplicate discard indication to lower layers. The main services and functions of the PDCP sublayer for the control plane include: sequence numbering; ciphering, deciphering and integrity protection; transfer of control plane data; reordering and duplicate detection; in-order delivery; duplication of PDCP PDUs and duplicate discard indication to lower layers.

In the 3GPP NR system, the main services and functions of SDAP include: mapping between a QoS flow and a data radio bearer; marking QoS flow ID (QFI) in both DL and UL packets. A single protocol entity of SDAP is configured for each individual PDU session.

In the 3GPP NR system, the main services and functions of the RRC sublayer include: broadcast of system information related to AS and NAS; paging initiated by 5GC or NG-RAN; establishment, maintenance and release of an RRC connection between the UE and NG-RAN; security functions including key management; establishment, configuration, maintenance and release of signaling radio bearers (SRBs) and data radio bearers (DRBs); mobility functions (including: handover and context transfer, UE cell selection and reselection and control of cell selection and reselection, inter-RAT mobility); QoS management functions; UE measurement reporting and control of the reporting; detection of and recovery from radio link failure; NAS message transfer to/from NAS from/to UE.

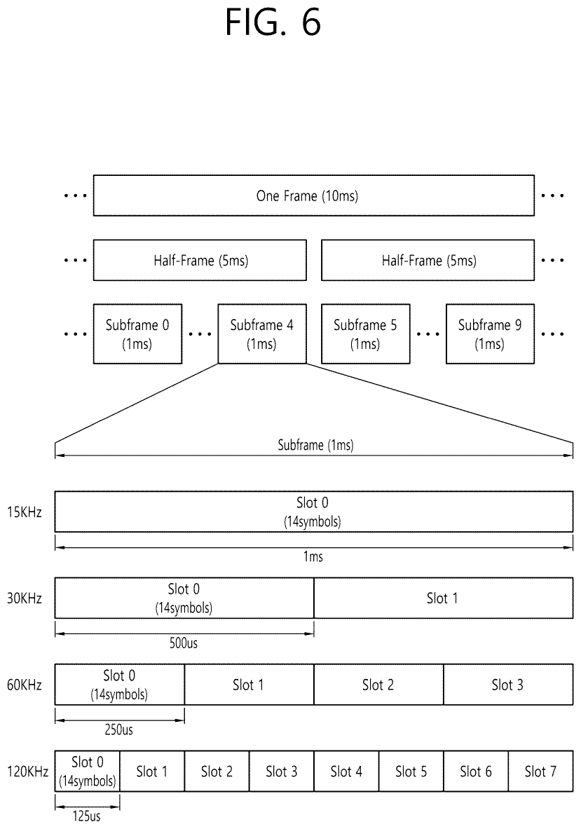

FIG. 6 shows a frame structure in a 3GPP based wireless communication system to which implementations of the present disclosure is applied.

The frame structure shown in FIG. 6 is purely exemplary and the number of subframes, the number of slots, and/or the number of symbols in a frame may be variously changed. In the 3GPP based wireless communication system, OFDM numerologies (e.g., subcarrier spacing (SCS), transmission time interval (TTI) duration) may be differently configured between a plurality of cells aggregated for one UE. For example, if a UE is configured with different SCSs for cells aggregated for the cell, an (absolute time) duration of a time resource (e.g., a subframe, a slot, or a TTI) including the same number of symbols may be different among the aggregated cells. Herein, symbols may include OFDM symbols (or CP-OFDM symbols), SC-FDMA symbols (or discrete Fourier transform-spread-OFDM (DFT-s-OFDM) symbols).

Referring to FIG. 6, downlink and uplink transmissions are organized into frames. Each frame has T_{f}=10 ms duration. Each frame is divided into two half-frames, where each of the half-frames has 5 ms duration. Each half-frame consists of 5 subframes, where the duration T_{sf} per subframe is 1 ms. Each subframe is divided into slots and the number of slots in a subframe depends on a subcarrier spacing. Each slot includes 14 or 12 OFDM symbols based on a cyclic prefix (CP). In a normal CP, each slot includes 14 OFDM symbols and, in an extended CP, each slot includes 12 OFDM symbols. The numerology is based on exponentially scalable subcarrier spacing βf=2^{u}*15 kHz.

Table 3 shows the number of OFDM symbols per slot N^{slot}_{symb}, the number of slots per frame N^{frame,u}ₛₗₒₜ, and the number of slots per subframe N^{subframe,u}ₛₗₒₜ for the normal CP, according to the subcarrier spacing Bf=2^{u}*15 kHz.

TABLE 3

| u | N^{slot}_{symb} | N^{frame, u}ₛₗₒₜ | N^{subframe, u}ₛₗₒₜ |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |

Table 4 shows the number of OFDM symbols per slot N^{slot}_{symb}, the number of slots per frame N^{frame,u}ₛₗₒₜ, and the number of slots per subframe N^{subframe,u}ₛₗₒₜ for the extended CP, according to the subcarrier spacing Bf=2^{u}*15 kHz.

TABLE 4

| u | N^{slot}_{symb} | N^{frame, u}ₛₗₒₜ | N^{subframe, u}ₛₗₒₜ |
|---|---|---|---|
| 2 | 12 | 40 | 4 |

A slot includes plural symbols (e.g., 14 or 12 symbols) in the time domain. For each numerology (e.g., subcarrier spacing) and carrier, a resource grid of N^{size,u}_{grid,x}*N^{RB}_{sc} subcarriers and N^{subframe,u}_{symb} OFDM symbols is defined, starting at common resource block (CRB) N^{start,u}_{grid} indicated by higher-layer signaling (e.g., RRC signaling), where N^{size,u}_{grid,x} is the number of resource blocks (RBs) in the resource grid and the subscript x is DL for downlink and UL for uplink. N^{RB}_{sc} is the number of subcarriers per RB. In the 3GPP based wireless communication system, N^{RB}_{sc} is 12 generally. There is one resource grid for a given antenna port p, subcarrier spacing configuration u, and transmission direction (DL or UL). The carrier bandwidth N^{size,u}_{grid} for subcarrier spacing configuration u is given by the higher-layer parameter (e.g., RRC parameter). Each element in the resource grid for the antenna port p and the subcarrier spacing configuration u is referred to as a resource element (RE) and one complex symbol may be mapped to each RE. Each RE in the resource grid is uniquely identified by an index k in the frequency domain and an index l representing a symbol location relative to a reference point in the time domain. In the 3GPP based wireless communication system, an RB is defined by 12 consecutive subcarriers in the frequency domain. As shown in FIG. 6, as SCS doubles, the slot length and symbol length are halved. For example, when SCS is 15 kHz, the slot length is 1 ms, which is the same as the subframe length. When SCS is 30 kHz, the slot length is 0.5 ms (=500 us), and the symbol length is half of that when the SCS is 15 kHz. When SCS is 60 kHz, the slot length is 0.25 ms (=250 us), and the symbol length is half of that when the SCS is 30 kHz. When SCS is 120 kHz, the slot length is 0.125 ms (=125 us), and the symbol length is half of that when the SCS is 60 kHz. When SCS is 240 kHz, the slot length is 0.0625 ms (=62.5 us), and the symbol length is half of that when the SCS is 120 KHz.

In the 3GPP NR system, RBs are classified into CRBs and physical resource blocks (PRBs). CRBs are numbered from 0 and upwards in the frequency domain for subcarrier spacing configuration w. The center of subcarrier 0 of CRB 0 for subcarrier spacing configuration u coincides with ‘point A’ which serves as a common reference point for resource block grids. In the 3GPP NR system, PRBs are defined within a bandwidth part (BWP) and numbered from 0 to N^{size}_{BWP,i}−1, where i is the number of the bandwidth part. The relation between the physical resource block n_{PRB} in the bandwidth part i and the common resource block n_{CRB} is as follows: N_{PRB}=N_{CRB}+N^{size}_{BWP,i}, where N^{size}_{BWP,i} is the common resource block where bandwidth part starts relative to CRB 0. The BWP includes a plurality of consecutive RBs. A carrier may include a maximum of N (e.g., 5) BWPs. A UE may be configured with one or more BWPs on a given component carrier. Only one BWP among BWPs configured to the UE can active at a time. The active BWP defines the UE's operating bandwidth within the cell's operating bandwidth.

In the present disclosure, the term “cell” may refer to a geographic area to which one or more nodes provide a communication system, or refer to radio resources. A “cell” as a geographic area may be understood as coverage within which a node can provide service using a carrier and a “cell” as radio resources (e.g., time-frequency resources) is associated with bandwidth which is a frequency range configured by the carrier. The “cell” associated with the radio resources is defined by a combination of downlink resources and uplink resources, for example, a combination of a DL component carrier (CC) and a UL CC. The cell may be configured by downlink resources only, or may be configured by downlink resources and uplink resources. Since DL coverage, which is a range within which the node is capable of transmitting a valid signal, and UL coverage, which is a range within which the node is capable of receiving the valid signal from the UE, depends upon a carrier carrying the signal, the coverage of the node may be associated with coverage of the “cell” of radio resources used by the node. Accordingly, the term “cell” may be used to represent service coverage of the node sometimes, radio resources at other times, or a range that signals using the radio resources can reach with valid strength at other times.

In CA, two or more CCs are aggregated. A UE may simultaneously receive or transmit on one or multiple CCs depending on its capabilities. CA is supported for both contiguous and non-contiguous CCs. When CA is configured, the UE only has one RRC connection with the network. At RRC connection establishment/re-establishment/handover, one serving cell provides the NAS mobility information, and at RRC connection re-establishment/handover, one serving cell provides the security input. This cell is referred to as the primary cell (PCell). The PCell is a cell, operating on the primary frequency, in which the UE either performs the initial connection establishment procedure or initiates the connection re-establishment procedure. Depending on UE capabilities, secondary cells (SCells) can be configured to form together with the PCell a set of serving cells. An SCell is a cell providing additional radio resources on top of special cell (SpCell). The configured set of serving cells for a UE therefore always consists of one PCell and one or more SCells. For dual connectivity (DC) operation, the term SpCell refers to the PCell of the master cell group (MCG) or the primary SCell (PSCell) of the secondary cell group (SCG). An SpCell supports PUCCH transmission and contention-based random access, and is always activated. The MCG is a group of serving cells associated with a master node, comprised of the SpCell (PCell) and optionally one or more SCells. The SCG is the subset of serving cells associated with a secondary node, comprised of the PSCell and zero or more SCells, for a UE configured with DC. For a UE in RRC_CONNECTED not configured with CA/DC, there is only one serving cell comprised of the PCell. For a UE in RRC_CONNECTED configured with CA/DC, the term “serving cells” is used to denote the set of cells comprised of the SpCell(s) and all SCells. In DC, two MAC entities are configured in a UE: one for the MCG and one for the SCG.

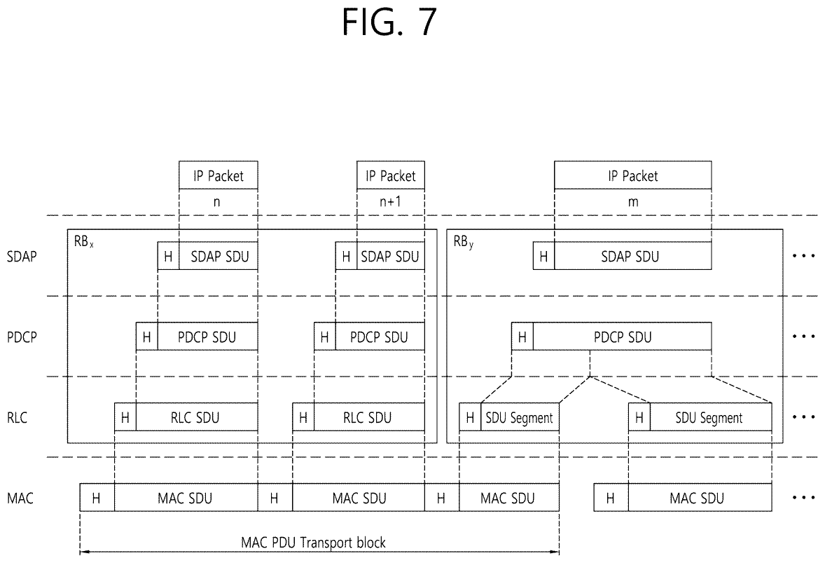

FIG. 7 shows a data flow example in the 3GPP NR system to which implementations of the present disclosure is applied.

Referring to FIG. 7, “RB” denotes a radio bearer, and “H” denotes a header. Radio bearers are categorized into two groups: DRBs for user plane data and SRBs for control plane data. The MAC PDU is transmitted/received using radio resources through the PHY layer to/from an external device. The MAC PDU arrives to the PHY layer in the form of a transport block.

In the PHY layer, the uplink transport channels UL-SCH and RACH are mapped to their physical channels physical uplink shared channel (PUSCH) and physical random access channel (PRACH), respectively, and the downlink transport channels DL-SCH, BCH and PCH are mapped to physical downlink shared channel (PDSCH), physical broadcast channel (PBCH) and PDSCH, respectively. In the PHY layer, uplink control information (UCI) is mapped to physical uplink control channel (PUCCH), and downlink control information (DCI) is mapped to physical downlink control channel (PDCCH). A MAC PDU related to UL-SCH is transmitted by a UE via a PUSCH based on an UL grant, and a MAC PDU related to DL-SCH is transmitted by a BS via a PDSCH based on a DL assignment.

Hereinafter, cell selection/reselection is described.

### I. Cell Selection Criterion

The cell selection criterion S is fulfilled when Srxlev>0 and Squal>0. Herein, Srxlev=Qᵣₓₗₑᵥₘₑₐₛ−(Qᵣₓₗₑᵥₘᵢₙ+Q_{rxlevminoffset})−P_{compensation}−Qoffsetₜₑₘₚ, and Squal=Q_{qualmeas}−(Q_{qualmin}+Q_{qualminoffset})−Qoffsetₜₑₘₚ. Parameters are defined as table 5:

TABLE 5

| | |
|---|---|
| Srxlev | Cell selection RX level value (dB) |
| Squal | Cell selection quality value (dB) |
| Qoffsetₜₑₘₚ | Offset temporarily applied to a cell as specified in TS |
| | 38.331 [3] (dB) |
| Qᵣₓₗₑᵥₘₑₐₛ | Measured cell RX level value (RSRP) |
| Q_{qualmeas} | Measured cell quality value (RSRQ) |
| Qᵣₓₗₑᵥₘᵢₙ | Minimum required RX level in the cell (dBm). If the |
| | UE supports SUL frequency for this cell, Qᵣₓₗₑᵥₘᵢₙ is obtained |
| | from q-RxLevMinSUL, if present, in SIB1, SIB2 and SIB4, |
| | additionally, if Q_{rxlevminoffsetcellSUL} is present in SIB3 and SIB4 |
| | for the concerned cell, this cell specific offset is added to the |
| | corresponding Qrxlevmin to achieve the required minimum RX |
| | level in the concerned cell; |
| | else Qᵣₓₗₑᵥₘᵢₙ is obtained from q-RxLevMin in SIB1, |
| | SIB2 and SIB4, additionally, if Q_{rxlevminoffsetcell} is present in SIB3 |
| | and SIB4 for the concerned cell, this cell specific offset is added |
| | to the corresponding Qrxlevmin to achieve the required |
| | minimum RX level in the concerned cell. |
| Q_{qualmin} | Minimum required quality level in the cell (dB). |
| | Additionally, if Q_{qualminoffsetcell} is signalled for the concerned |
| | cell, this cell specific offset is added to achieve the required |
| | minimum quality level in the concerned cell. |
| Q_{rxlevminoffset} | Offset to the signalled Qᵣₓₗₑᵥₘᵢₙ taken into account in the |
| | Srxlev evaluation as a result of a periodic search for a higher |
| | priority PLMN while camped normally in a VPLMN, as |
| | specified in TS 23.122 [9]. |
| Q_{qualminoffset} | Offset to the signalled Q_{qualmin} taken into account in the |
| | Squal evaluation as a result of a periodic search for a higher |
| | priority PLMN while camped normally in a VPLMN, as |
| | specified in TS 23.122 [9]. |
| P_{compensation} | For FR1, if the UE supports the additionalPmax in the |
| | NR-NS-PmaxList, if present, in SIB1, SIB2 and SIB4: |
| | max(P_{EMAX1} − P_{PowerClass,} 0) − (min(P_{EMAX2}, P_{PowerClass}) − |
| | min(P_{EMAX1}, P_{PowerClass})) (dB); |
| | else: |
| | max(P_{EMAX1} − P_{PowerClass}, 0) (dB) |
| | For FR2, P_{compensation} is set to 0. |
| | For IAB-MT, P_{compensation} is set to 0. |
| P_{EMAX1}, P_{EMAX2} | Maximum TX power level of a UE may use when |
| | transmitting on the uplink in the cell (dBm) defined as P_{EMAX} in |
| | TS 38.101 [15]. If UE supports SUL frequency for this cell, |
| | P_{EMAX1} and P_{EMAX2} are obtained from the p-Max for SUL in |
| | SIB1 and NR-NS-PmaxList for SUL respectively in SIB1, SIB2 |
| | and SIB4 as specified in TS 38.331 [3], else P_{EMAX1} and P_{EMAX2} |
| | are obtained from the p-Max and NR-NS-PmaxList |
| | respectively in SIB1, SIB2 and SIB4 for normal UL as specified |
| | in TS 38.331 [3]. |
| P_{PowerClass} | Maximum RF output power of the UE (dBm) |
| | according to the UE power class. |

The signalled values Q_{rxlevminoffset} and Q_{qualminoffset} are only applied when a cell is evaluated for cell selection as a result of a periodic search for a higher priority PLMN while camped normally in a VPLMN. During this periodic search for higher priority PLMN, the UE may check the S criteria of a cell using parameter values stored from a different cell of this higher priority PLMN.

### II. Reselection Priorities Handling

Absolute priorities of different NR frequencies or inter-RAT frequencies may be provided to the UE in the system information, in the RRCRelease message, or by inheriting from another RAT at inter-RAT cell (re) selection. In the case of system information, an NR frequency or inter-RAT frequency may be listed without providing a priority (i.e., the field cellReselectionPriority is absent for that frequency). If any fields with cellReselectionPriority are provided in dedicated signalling, the UE shall ignore any fields with cellReselectionPriority and any slice reselection information provided in system information. If slice reselection information is provided in dedicated signaling, the UE shall ignore slice reselection information provided in system information.

In some implementations, information provided in RRCRelease may override information provided in SIB. This may include slice-specific re-selection information, existing/legacy cellResleectionPriority.

In some implementations, “PCI-lists” may be provided in RRCRelease.

If UE is in camped normally state and UE supports slice-based cell reselection, UE shall derive re-selection priorities.

If UE is in camped on any cell state, UE shall only apply the priorities provided by system information from current cell, and the UE preserves priorities provided by dedicated signalling and deprioritisationReq received in RRCRelease unless specified otherwise. When the UE in camped normally state, has only dedicated priorities other than for the current frequency, the UE shall consider the current frequency to be the lowest priority frequency (i.e. lower than any of the network configured values). When the HSDN capable UE is in High-mobility state, the UE shall always consider the HSDN cells to be the highest priority (i.e., higher than any other network configured priorities). When the HSDN capable UE is not in High-mobility state, the UE shall always consider HSDN cells to be the lowest priority (i.e., lower than any other network configured priorities). If the UE is configured to perform both NR sidelink communication and V2X sidelink communication, the UE may consider the frequency providing both NR sidelink communication configuration and V2X sidelink communication configuration to be the highest priority. If the UE is configured to perform NR sidelink communication and not perform V2X communication, the UE may consider the frequency providing NR sidelink communication configuration to be the highest priority. If the UE is configured to perform V2X sidelink communication and not perform NR sidelink communication, the UE may consider the frequency providing V2X sidelink communication configuration to be the highest priority.

The frequency only providing the anchor frequency configuration should not be prioritized for V2X service during cell reselection.

When UE is configured to perform NR sidelink communication or V2X sidelink communication performs cell reselection, it may consider the frequencies providing the intra-carrier and inter-carrier configuration have equal priority in cell reselection.

The prioritization among the frequencies which UE considers to be the highest priority frequency is left to UE implementation.

The UE is configured to perform V2X sidelink communication or NR sidelink communication, if it has the capability and is authorized for the corresponding sidelink operation.

When UE is configured to perform both NR sidelink communication and V2X sidelink communication, but cannot find a frequency which can provide both NR sidelink communication configuration and V2X sidelink communication configuration, UE may consider the frequency providing either NR sidelink communication configuration or V2X sidelink communication configuration to be the highest priority.

The UE is configured with either dedicated priorities or slice or slice group specific frequency priorities in the RRCRelease message.

The UE shall only perform cell reselection evaluation for NR frequencies and inter-RAT frequencies that are given in system information and for which the UE has a priority provided.

If the MBS broadcast capable UE is receiving or interested to receive an MBS broadcast service(s) and can only receive this MBS broadcast service(s) by camping on a frequency on which it is provided, the UE may consider that frequency to be the highest priority during the MBS broadcast session as long as the two following conditions are fulfilled:
1) The cell reselected by the UE due to frequency prioritization for MBS is providing SIB20;
2) Either:
   One or more MBS FSAI(s) of that frequency is indicated in SIB21 of the serving cell and the same MBS FSAI(s) is also indicated for this MBS broadcast service in MBS User Service Description (USD), or
   SIB21 is not provided in the serving cell and that frequency is included in the USD of this service, or
   SIB21 is provided in the serving cell but does not provide the frequency mapping for the concerned service, and that frequency is included in the USD of this service.

It is up to UE implementation how to use information in USD to determine whether/how to do the frequency prioritization for specific frequency/frequencies included in USD.

If the MBS broadcast capable UE is receiving or interested to receive an MBS broadcast service(s), the UE may consider cell reselection candidate frequencies at which it can not receive the MBS broadcast service to be of the lowest priority during the MBS broadcast session as specified in TS 38.300 [2], as long as the SIB20 is provided by the cell on the MBS frequency which the UE monitors and as long as the condition 2) above is fulfilled for the serving cell.

In case UE receives RRCRelease with deprioritisationReq, UE shall consider current frequency and stored frequencies due to the previously received RRCRelease with deprioritisationReq or all the frequencies of NR to be the lowest priority frequency (i.e. lower than any of the network configured values) while T325 is running irrespective of camped RAT. The UE shall delete the stored deprioritisation request(s) when a PLMN selection or SNPN selection is performed on request by NAS.

UE should search for a higher priority layer for cell reselection as soon as possible after the change of priority. The minimum related performance requirements are still applicable.

The UE shall delete priorities provided by dedicated signalling when:
the UE enters a different RRC state; or
the optional validity time of dedicated priorities (T320) expires; or
the UE receives an RRCRelease message with the field cellReselectionPriorities absent; or
a PLMN selection or SNPN selection is performed on request by NAS.

The UE shall not consider any exclude-listed cells as candidate for cell reselection.

The UE shall consider only the allow-listed cells, if configured, as candidates for cell reselection.

The UE in RRC_IDLE state shall inherit the priorities provided by dedicated signalling and the remaining validity time (i.e. T320 in NR and E-UTRA), if configured, at inter-RAT cell (re)selection.

The network may assign dedicated cell reselection priorities for frequencies not configured by system information.

### III. Inter-Frequency and Inter-RAT Cell Reselection Criteria

If threshServingLowQ is broadcast in system information and more than 1 second has elapsed since the UE camped on the current serving cell, cell reselection to a cell on a higher priority NR frequency or inter-RAT frequency than the serving frequency shall be performed if a cell of a higher priority NR or EUTRAN RAT/frequency fulfils Squal>Thresh_{X, HighQ} during a time interval Treselection_{RAT}.

Otherwise, cell reselection to a cell on a higher priority NR frequency or inter-RAT frequency than the serving frequency shall be performed if i) a cell of a higher priority RAT/frequency fulfils Srxlev>Thresh_{X, HighP} during a time interval Treselection_{RAT}; and ii) more than 1 second has elapsed since the UE camped on the current serving cell.

Cell reselection to a cell on an equal priority NR frequency shall be based on ranking for intra-frequency cell reselection.

If threshServingLowQ is broadcast in system information and more than 1 second has elapsed since the UE camped on the current serving cell, cell reselection to a cell on a lower priority NR frequency or inter-RAT frequency than the serving frequency shall be performed if the serving cell fulfils Squal<Thresh_{serving, LowQ} and a cell of a lower priority NR or E-UTRAN RAT/frequency fulfils Squal>Thresh_{X, LowQ} during a time interval Treselection_{RAT}.

Otherwise, cell reselection to a cell on a lower priority NR frequency or inter-RAT frequency than the serving frequency shall be performed if i) the serving cell fulfils Srxlev<Thresh_{serving, LowP} and a cell of a lower priority RAT/frequency fulfils Srxlev>Thresh_{X, LowP} during a time interval Treselection_{RAT}; and ii) more than 1 second has elapsed since the UE camped on the current serving cell.

For a UE performing slice-based cell reselection if a cell fulfils the above criteria for cell reselection based on re-selection priority for the frequency and slice group, but this cell does not support the slice group, the UE shall re-derive a re-selection priority for the frequency by considering the slice group(s) supported by this cell (rather than those of the corresponding NR frequency). This reselection priority shall be used until the highest ranked cell changes on the frequency, or new slice or slice group priorities are received from NAS. UE shall ensure the cell reselection criteria above are fulfilled based on the newly derived priorities.

Cell reselection to a higher priority RAT/frequency shall take precedence over a lower priority RAT/frequency if multiple cells of different priorities fulfil the cell reselection criteria.

If more than one cell meets the above criteria, the UE shall reselect a cell if the highest-priority frequency is an NR frequency, the highest ranked cell among the cells on the highest priority frequency(ies) meeting the criteria according to clause; and/or if the highest-priority frequency is from another RAT, the strongest cell among the cells on the highest priority frequency(ies) meeting the criteria of that RAT.

### IV. Intra-Frequency and Equal Priority Inter-Frequency Cell Reselection Criteria

The cell-ranking criterion Rₛ for serving cell and Rₙ for neighbouring cells is defined by:
Rₛ=Q_{meas,s}+Q_{hyst}−Qoffsetₜₑₘₚ; and Rₙ=Q_{meas,n}−Qoffset−Qoffsetₜₑₘₚ. Parameters are defined as table 6:

TABLE 6

| | |
|---|---|
| Qₘₑₐs | RSRP measurement quantity used in cell |
| | reselections. |
| Qoffset | For intra-frequency: Equals to Qoffset_{s, n}, if |
| | Qoffset_{s, n} is valid, otherwise this equals to zero. For |
| | inter-frequency: Equals to Qoffset_{s, n} plus |
| | Qoffset_{frequency}, if Qoffset_{s, n} is valid, otherwise this |
| | equals to Qoffset_{frequency}. |
| Qoffsetₜₑₘₚ | Offset temporarily applied to a cell. |

The UE shall perform ranking of all cells that fulfil the cell selection criterion S. The cells shall be ranked according to the R criteria specified above by deriving Q_{meas,n} and Q_{meas,s} and calculating the R values using averaged RSRP results.

If range ToBestCell is not configured, the UE shall perform cell reselection to the highest ranked cell. If this cell is found to be not-suitable, the UE shall not consider this cell and, for operation in licensed spectrum, other cells on the same frequency as candidates for reselection for a maximum of 300 seconds.

If range ToBestCell is configured, then the UE shall perform cell reselection to the cell with the highest number of beams above the threshold (i.e. absThreshSS-BlocksConsolidation) among the cells whose R value is within range ToBestCell of the R value of the highest ranked cell. If there are multiple such cells, the UE shall perform cell reselection to the highest ranked cell among them. If this cell is found to be not-suitable, the UE shall not consider this cell and, for operation in licensed spectrum, other cells on the same frequency as candidates for reselection for a maximum of 300 seconds.

In all cases, the UE shall reselect the new cell, only if i) the new cell is better than the serving cell according to the cell reselection criteria specified above during a time interval Treselection_{RAT}; and/or ii) more than 1 second has elapsed since the UE camped on the current serving cell.

If range ToBestCell is configured but absThreshSS-BlocksConsolidation is not configured on an NR frequency, the UE considers that there is one beam above the threshold for each cell on that frequency.

Meanwhile, there may be cell reselection scenarios where a cell mounted in a mobile object exists as shown below:
1) Scenario 1 (S1): Non-on-board UE reselects a mobile cell that is temporarily in proximity
   S1-1: Stationary non-on-board UE reselects a mobile cell in proximity.
   S1-1: Mobile non-on-board UE reselects a mobile cell in proximity.
2) S2: On-board UE inside a mobile IAB node reselects other cell than the mobile cell
   S2-1: While mobile IAB node is moving, on-board UE (stationary or moving) reselects other cell than the mobile cell.
   S2-2: Mobile IAB node is temporary stationary, and on-board UE will reselect other cell than the mobile cell.

In S1, unnecessary reselection to mobile cells may happen to non-on-board UEs. In S2, unnecessary reselection to other cells than a mobile cell may happen to on-board UEs.

Unnecessary reselections in S1 can be easily avoided by configuring the cell reselection frequency priority (CRP) of the mobile cell with lower CRP value. CRP configuration may be up to network implementation and no new mechanism is needed.

However, configuring lower CRP for mobile cells does not solve the problem in S2. Instead, it deteriorates the problem in S2, because on-board UEs will attempt measure and reselect other cells (e.g., other stationary cells) of higher CRP.

To avoid the problem in S2, on-board UEs should be able to stick to the current mobile cell as long as the current mobile cell provides reasonable signal quality and the UE is indeed on-board in the mobile cell. The possible means to enable UEs to stick to the current mobile cell would be to prioritize the mobile cell than other cells with respect to cell reselection.

To prioritize a cell against other inter-frequency cells, the on-board UEs may be allowed to consider CRP of the mobile cell frequency to be the highest CRP if the consolidated prioritization condition given below is met.

To prioritize a cell against other intra-frequency cells, the on-board UEs may be allowed to apply a positive cell-specific offset to the mobile cell if the consolidated prioritization condition given below is met.

According to various embodiments, the consolidated prioritization condition for a cell may comprise at least one of a minimum cell quality condition, a mobile cell identification condition, a real-time mobility status condition, or a relative mobility state condition. If the consolidated condition is met, UE can prioritize the cell/frequency.

### 1. Minimum Cell Quality Condition

The minimum cell quality condition is a condition that a quality of the cell is higher than the minimum cell quality (i.e., threshold). If the minimum cell quality condition is not applied, UE may prioritize a cell with very low signal quality, which is undesirable.

### 2. Mobile Cell Identification Condition

The mobile cell identification condition is a condition that the concerned cell is identified as a mobile cell.

Indication of whether a cell is a mobile cell or not can be signalled via:
neighbour cell information (i.e., system information block 3 (SIB3) and/or SIB4); and/or
serving cell information (i.e., SIB1).

The indication does not mean that the cell is currently moving or not. The indication may only indicate that the cell may move potentially (i.e., the cell is capable of potentially moving/the cell has a capability of mobility). That is, the mobile cell may be a cell capable of moving regardless of actually moving.

If the mobile cell identification condition is not applied, the UE may prioritize a cell that has not a capability of mobility, which is undesirable.

### 3. Real-Time Mobility Status Condition

The real-time mobility status condition is a condition that a real-time mobility status of the concerned cell is a moving status (i.e., the cell is currently moving). The UE may receive, from a cell via broadcast/dedicated signalling, mobility status information indicating whether the cell is in a moving status (i.e., currently moving) or in a stationary status (i.e., currently not moving). That is, the mobility status information may indicate a mobility status of the cell (e.g., moving status or stationary status), and/or that the cell is currently moving or the cell is currently stationary (i.e., not moving/in a stationary status).

UE can acquire the real-time mobility status of a cell when the UE is camping on the cell. The UE can apply the real-time mobility status condition only when the UE is currently camping on the cell. That is, if the real-time mobility status condition is applied, UE can prioritize the current serving cell/frequency only if the current serving cell is indicated as “moving” and other applicable conditions are also met.

If the real-time mobility status condition is not applied, the UE may prioritize a cell that is currently stationary. This result may be acceptable in case the time of being stationary is long enough. On the other hand, if the real-time mobility status condition is applied, UE that has been on-board in a mobile cell but is now leaving the mobile cell may keep camping on the mobile cell longer than necessary. Then, it may be beneficial to give network control of whether or not the UE shall apply/evaluate the real-time mobility status condition as necessary condition for prioritizing the cell/frequency, by signalling a control flag in SIB for that purpose along with the real-time mobility status of the cell. Or, it is possible that the real-time mobility status condition is not used in the consolidated condition.

### 4. Relative Mobility State Condition

The relative mobility state condition is a condition that a relative mobility state between UE and the concerned cell is low/static. The relative mobility state between UE and a cell may be determined as low/static when the variation of the measured signal quality of the cell over time is sufficiently small and/or the time average of measured signal quality of the cell remains almost the same over time and/or the time average of measured signal quality of the cell changes within a given constant.

For example, the relative mobility state between UE and a cell may be determined as low/static when a variation of a measured signal quality of the cell during a running but fixed-size duration is lower than a threshold.

For example, the relative mobility state between UE and a cell may be determined as low/static when a variation of an average of a measured signal quality of the cell during a running but fixed-size duration is lower than a threshold.

If the threshold is properly configured, the moving UE within the mobile cell can be still consider the mobile cell as relatively low/static state.

If the relative mobility state condition is not applied, the UE may prioritize a cell in which the UE is not on-board.

If a relative mobility state between a cell and UE is determined based on radio quality measurements and/or positioning measurements, and the relative mobility state is low/static (i.e., relative static state), it is highly likely that the UE is actually on-board in the cell.

If non-on-board UE applies the relative mobility state condition, the relative mobility state between the UE and a mobile cell that is moving in proximity may be observed as not being low/static mobility state (i.e., relative moving state). Then, the non-on-board UE may avoid prioritizing the cell.

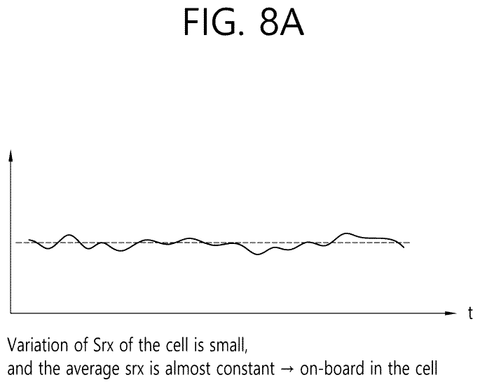

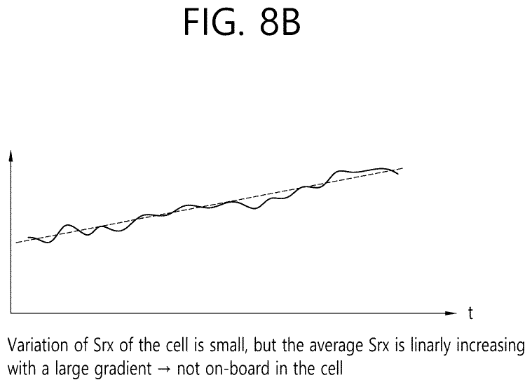

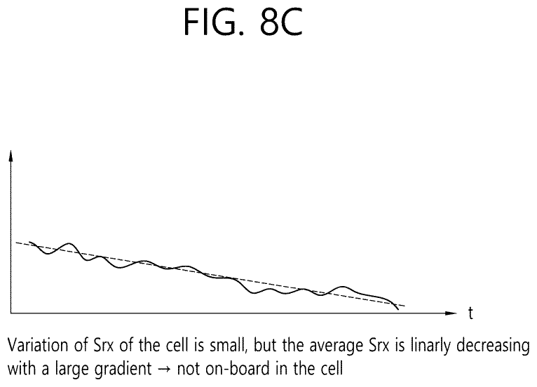

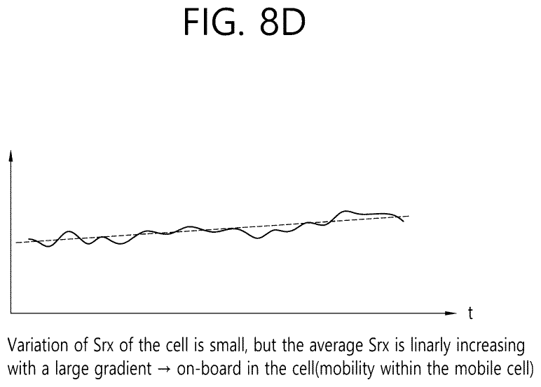

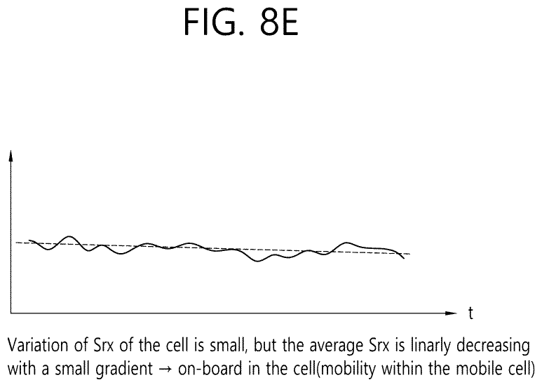

FIGS. 8A to 8E shows examples of Srxlev graphs related to relative mobility state between UE and cell according to an embodiment of the present disclosure. In the present disclosure:
Srxlev can be substituted for a signal quality for the concerned cell;
a variation of an Srxlev for a cell during a time period may be a difference between a maximum value of the Srxlev for the cell and a minimum value of the Srxlev for the cell during the time period; and/or
an average of an Srxlev for a cell during a time period may be a moving average of the Srxlev for the cell during the time period.

Referring to FIG. 8A, a variation of an Srxlev for a cell is small during a time period, and an average of the Srxlev for the cell is almost constant during the time period. In this case, the UE may determine a relative mobility state between the UE and the cell as being low/static, and/or determine that the UE is on-board in the cell.

Referring to FIG. 8B, a variation of an Srxlev for a cell is small during a time period, but an average of the Srxlev for the cell is linearly increasing with a large gradient during the time period. In this case, the UE may determine a relative mobility state between the UE and the cell as not being low/static, and/or determine that the UE is not on-board in the cell.

Referring to FIG. 8C, a variation of an Srxlev for a cell is small during a time period, but an average of the Srxlev for the cell is linearly decreasing with a large gradient during the time period. In this case, the UE may determine a relative mobility state between the UE and the cell as not being low/static, and/or determine that the UE is not on-board in the cell.

Referring to FIG. 8D a variation of an Srxlev for a cell is small during a time period, and average of the Srxlev for the cell is linearly increasing with a small gradient during the time period. In this case, the UE may determine a relative mobility state between the UE and the cell as being low/static, and/or determine that the UE is on-board in the cell. This case may correspond to a case where the UE moves within the cell (i.e., mobile cell).

Referring to FIG. 8E a variation of an Srxlev for a cell is small during a time period, and an average of the Srxlev for the cell is linearly decreasing with a small gradient during the time period. In this case, the UE may determine a relative mobility state between the UE and the cell as being low/static, and/or determine that the UE is on-board in the cell. This case may correspond to a case where the UE moves within the cell (i.e., mobile cell).

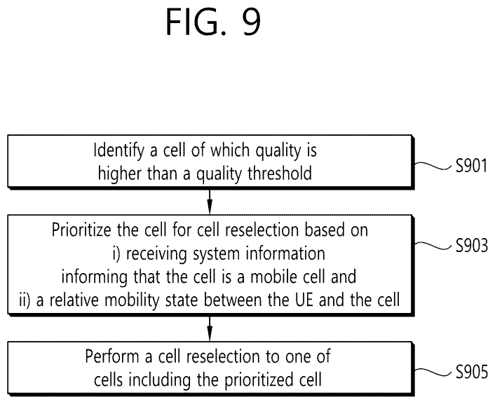

FIG. 9 shows an example of a method performed by a UE according to an embodiment of the present disclosure. The method may also be performed by a wireless device.

Referring to FIG. 9, in step S901, the UE may identify a cell of which quality is higher than a quality threshold.

In step S903, the UE may prioritize the cell for cell reselection based on i) receiving system information informing that the cell is a mobile cell; and ii) a relative mobility state between the UE and the cell.

In step S905, the UE may perform a cell reselection to one of cells including the prioritized cell.

According to various embodiments, the UE may prioritize the cell over other inter-frequency cells by setting a priority of a frequency on which the cell exists to be highest.

According to various embodiments, the UE may prioritize the cell over other intra-frequency cells by adding a positive offset value to a cell ranking value of the cell.

According to various embodiments, the UE may perform a cell reselection to a cell of which cell ranking value is highest on a frequency with highest priority.

According to various embodiments, the mobile cell may be a cell capable of moving regardless of actually moving.

According to various embodiments, the system information may comprise at least one of a system information block (SIB) related to neighbor cell information, or an SIB related to serving cell information.

According to various embodiments, the SIB related to neighbor cell information may comprise at least one of SIB3 or SIB4. The SIB related to serving cell information may comprise SIB1.

According to various embodiments, the UE may receive information informing a mobility status of the cell. The mobility status may comprise at least one of a moving status that the cell is currently moving, or a stationary status that the cell is currently not moving. The UE may prioritize the cell for cell reselection based on the mobility status of the cell being the moving status.

According to various embodiments, the UE may receive a control signalling instructing to evaluate the mobility status of the cell for prioritizing the cell.

According to various embodiments, the UE may evaluate the mobility status of the cell for prioritizing the cell based on currently camping on the cell.

According to various embodiments, the UE may evaluate the mobility status of the cell for prioritizing the cell which the UE is not currently camping on.

According to various embodiments, the relative mobility state may comprise at least one of a relative moving state or a relative static state. The cell may be prioritized based on the relative mobility state being the relative static state.

According to various embodiments, the relative mobility state may be determined as the relative static state based on the UE being on-board in an object associated with the cell.

According to various embodiments, the UE may measure a signal quality for the cell during a time period. The UE may determine a moving average of the signal quality during the time period. The relative static state may comprise at least one of: a state in which a difference between a maximum value of the signal quality and a minimum value of the signal quality during the time period is less than a first threshold; or a state in which an absolute gradient of the moving average of the signal quality during the time period is lower than a second threshold. The relative moving state may comprise at least one of: a state in which a difference between the maximum value of the signal quality and the minimum value of the signal quality during the time period is larger than the first threshold; or a state in which an absolute gradient of the moving average of the signal quality during the time period is higher than the second threshold.

According to various embodiments, UE may identify a first state to determine if quality of a cell is beyond a threshold. The UE may identify a second state to determine if the cell is a mobile cell. The UE may identify a third state to determine the cell is currently moving. The UE may identify a fourth state to determine if relative mobility state between the UE and the cell is low or static. The UE may prioritize the cell for cell reselection based on the identified states. The prioritization may be based on applying cell reselection priority of the cell to be the highest value or applying an offset to the cell.

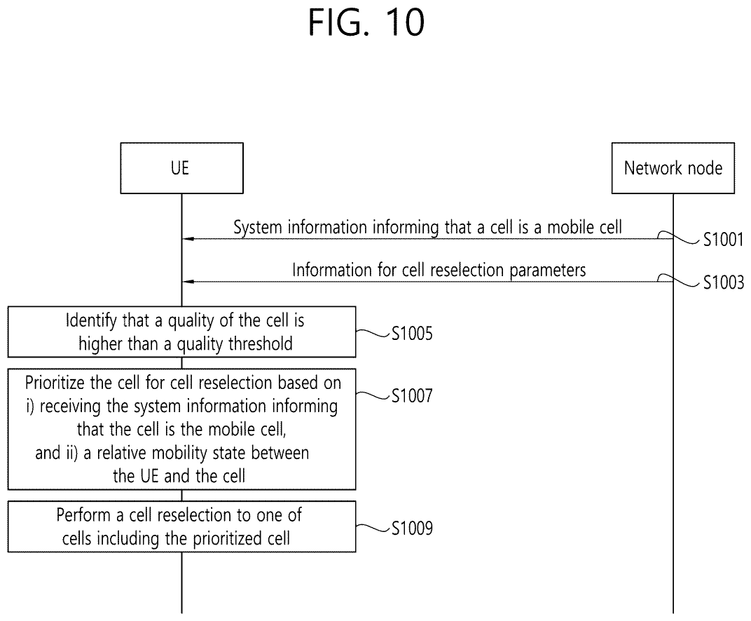

FIG. 10 shows an example of a signal flow between a network node and a UE according to an embodiment of the present disclosure. The network node may comprise a base station (BS).

Referring to FIG. 10, in step S1001, the network node may transmit, to a UE, system information informing that a cell is a mobile cell.

In step S1003, the network node may transmit, to the UE, information for cell reselection parameters. For example, the cell reselection parameters may comprise at least one of a priority of a frequency related to the cell, or a cell ranking offset value.

In some implementations, step S1001 and step S1003 may be performed simultaneously. For example, the information for the cell reselection parameters may be included in the system information, or transmitted together with information informing that the cell is the mobile cell. As another example, the order in which steps S1001 and S1003 are performed may be changed.

In step S1005, the UE may identify that a quality of the cell is higher than a quality threshold.

In step S1007, the UE may prioritize the cell for cell reselection based on i) receiving the system information informing that the cell is the mobile cell, and ii) a relative mobility state between the UE and the cell.

In step S1009, the UE may perform a cell reselection to one of cells including the prioritized cell.

Furthermore, the method in perspective of the UE described in the present disclosure (e.g., in FIG. 9) may be performed by the first wireless device 100 shown in FIG. 2 and/or the UE 100 shown in FIG. 3.

More specifically, the UE comprises at least one transceiver, at least processor, and at least one computer memory operably connectable to the at least one processor and storing instructions that, based on being executed by the at least one processor, perform operations.

The operations comprise: identifying a cell of which quality is higher than a quality threshold; prioritizing the cell for cell reselection based on i) receiving system information informing that the cell is a mobile cell; and ii) a relative mobility state between the UE and the cell; and performing a cell reselection to one of cells including the prioritized cell.

Furthermore, the method in perspective of the UE described in the present disclosure (e.g., in FIG. 9) may be performed by a software code 105 stored in the memory 104 included in the first wireless device 100 shown in FIG. 2.

More specifically, at least one computer readable medium (CRM) stores instructions that, based on being executed by at least one processor, perform operations comprising: identifying a cell of which quality is higher than a quality threshold; prioritizing the cell for cell reselection based on i) receiving system information informing that the cell is a mobile cell; and ii) a relative mobility state between the UE and the cell; and performing a cell reselection to one of cells including the prioritized cell.

Furthermore, the method in perspective of the UE described in the present disclosure (e.g., in FIG. 9) may be performed by control of the processor 102 included in the first wireless device 100 shown in FIG. 2 and/or by control of the processor 102 included in the UE 100 shown in FIG. 3.

More specifically, an apparatus configured to/adapted to operate in a wireless communication system (e.g., wireless device/UE) comprises at least processor, and at least one computer memory operably connectable to the at least one processor. The at least one processor is configured to/adapted to perform operations comprising: identifying a cell of which quality is higher than a quality threshold; prioritizing the cell for cell reselection based on i) receiving system information informing that the cell is a mobile cell; and ii) a relative mobility state between the UE and the cell; and performing a cell reselection to one of cells including the prioritized cell.

Furthermore, the method in perspective of a network node described in the present disclosure (e.g., in FIG. 10) may be performed by the second wireless device 200 shown in FIG. 2.

More specifically, the network node comprises at least one transceiver, at least processor, and at least one computer memory operably connectable to the at least one processor and storing instructions that, based on being executed by the at least one processor, perform operations.

The operations comprise: transmitting, to a user equipment (UE), system information informing that a cell is a mobile cell; and transmitting, to the UE, information for cell reselection parameters, wherein the UE is configured to: identify that a quality of the cell is higher than a quality threshold; prioritize the cell for cell reselection based on i) receiving the system information informing that the cell is the mobile cell, and ii) a relative mobility state between the UE and the cell; and perform a cell reselection to one of cells including the prioritized cell.

The present disclosure may have various advantageous effects.

For example, the UE prioritizes the current serving cell that satisfies the consolidated condition so that the UE can keep camping on the cell.

For example, the UE prioritizes a neighbour cell that satisfies the consolidated condition so that the UE can reselect the cell.

For example, on-board UEs in mobile cell can avoid unnecessary cell reselections, and/or non-onboard UEs can avoid unnecessary reselections.

Advantageous effects which can be obtained through specific embodiments of the present disclosure are not limited to the advantageous effects listed above. For example, there may be a variety of technical effects that a person having ordinary skill in the related art can understand and/or derive from the present disclosure. Accordingly, the specific effects of the present disclosure are not limited to those explicitly described herein, but may include various effects that may be understood or derived from the technical features of the present disclosure.

Claims in the present disclosure can be combined in a various way. For instance, technical features in method claims of the present disclosure can be combined to be implemented or performed in an apparatus, and technical features in apparatus claims can be combined to be implemented or performed in a method. Further, technical features in method claim(s) and apparatus claim(s) can be combined to be implemented or performed in an apparatus. Further, technical features in method claim(s) and apparatus claim(s) can be combined to be implemented or performed in a method. Other implementations are within the scope of the following claims.

1. A method comprising:
identifying a cell of which quality is higher than a quality threshold;
prioritizing the cell for cell reselection based on i) receiving, from a network, system information informing that the cell is a mobile cell; and ii) a relative mobility state between a user equipment (UE) and the cell; and
performing a cell reselection to one of cells including the prioritized cell.

2. The method of claim 1, wherein the prioritizing the cell comprises prioritizing the cell over other inter-frequency cells by setting a priority of a frequency on which the cell exists to be highest.

3. The method of claim 1, wherein the prioritizing the cell comprises prioritizing the cell over other intra-frequency cells by adding a positive offset value to a cell ranking value of the cell.

4. The method of claim 1, wherein the performing of the cell reselection comprises performing a cell reselection to a cell of which cell ranking value is highest on a frequency with highest priority.

5. The method of claim 1, wherein the mobile cell is a cell capable of moving regardless of actually moving.

6. The method of claim 1, wherein the system information comprises at least one of a system information block (SIB) related to neighbor cell information, or an SIB related to serving cell information.

7. The method of claim 1, wherein the SIB related to neighbor cell information comprises at least one of SIB3 or SIB4, and
wherein the SIB related to serving cell information comprises SIB1.

8. The method of claim 1, further comprising:
receiving information informing a mobility status of the cell,
wherein the mobility status comprises at least one of a moving status that the cell is currently moving, or a stationary status that the cell is currently not moving, and
wherein the prioritizing the cell for cell reselection comprises prioritizing the cell for cell reselection based on the mobility status of the cell being the moving status.

9. The method of claim 8, further comprising:
receiving a control signalling instructing to evaluate the mobility status of the cell for prioritizing the cell.

10. The method of claim 8, further comprising:
evaluating the mobility status of the cell for prioritizing the cell based on currently camping on the cell.

11. The method of claim 8, further comprising:
evaluating the mobility status of the cell for prioritizing the cell which the UE is not currently camping on.

12. The method of claim 1, wherein the relative mobility state comprises at least one of a relative moving state or a relative static state, and
wherein the cell is prioritized based on the relative mobility state being the relative static state.

13. The method of claim 12, wherein the relative mobility state is determined as the relative static state based on the UE being on-board in an object associated with the cell.

14. The method of claim 12, further comprising:
measuring a signal quality for the cell during a time period; and
determining a moving average of the signal quality during the time period,
wherein the relative static state comprises at least one of:
a state in which a difference between a maximum value of the signal quality and a minimum value of the signal quality during the time period is less than a first threshold; or
a state in which an absolute gradient of the moving average of the signal quality during the time period is lower than a second threshold; and
wherein the relative moving state comprises at least one of:
a state in which a difference between the maximum value of the signal quality and the minimum value of the signal quality during the time period is larger than the first threshold; or
a state in which an absolute gradient of the moving average of the signal quality during the time period is higher than the second threshold.

15. The method of claim 1, wherein the UE is in communication with at least one of a mobile device, a network, or autonomous vehicles.

16. A user equipment (UE) configured to operate in a wireless communication system, the UE comprising:
at least one transceiver;
at least one processor; and
at least one memory operatively coupled to the at least one processor and storing instructions that, based on being executed by the at least one processor, perform operations comprising:
identifying a cell of which quality is higher than a quality threshold;
prioritizing the cell for cell reselection based on i) receiving system information informing that the cell is a mobile cell; and ii) a relative mobility state between the UE and the cell; and
performing a cell reselection to one of cells including the prioritized cell.

17. (canceled)

18. A network node configured to operate in a wireless communication system, the network node comprising:
at least one transceiver;
at least one processor; and
at least one memory operatively coupled to the at least one processor and storing instructions that, based on being executed by the at least one processor, perform operations comprising:
transmitting, to a user equipment (UE), system information informing that a cell is a mobile cell; and
transmitting, to the UE, information for cell reselection parameters,
wherein the UE is configured to:
identify that a quality of the cell is higher than a quality threshold;
prioritize the cell for cell reselection based on i) receiving the system information informing that the cell is the mobile cell, and ii) a relative mobility state between the UE and the cell; and
perform a cell reselection to one of cells including the prioritized cell.

19-22. (canceled)
